(19) United States
(12) Patent Application Publication
(10) Pub. No.: US 2023/0136367 A1
(43) Pub. Date: May 4, 2023

(54) DEVICE AND METHODS FOR PREVENTING WEED GROWTH AND/OR GRASS GROWTH

(71) Applicant: Michael Coreno, Mechanicville, NY (US)

(72) Inventor: Michael Coreno, Mechanicville, NY (US)

(21) Appl. No.: 17/936,187

(22) Filed: Sep. 28, 2022

Related U.S. Application Data
(60) Provisional application No. 63/275,751, filed on Nov. 4, 2021.

(51) Int. Cl. E04H 17/06; A01G 9/28

(52) U.S. Cl. CPC E04H 17/063; A01G 9/28

(57) ABSTRACT

A fence guide device includes a first guard section and a second guard section. Each guard section includes a top and a bottom surface substantially parallel to each other. An inclined side surface extends laterally between the top and bottom surfaces. The first and second guard sections are configured to be positioned under a fence and abutted together at respective longitudinal ends of each guard section. When a lawn mower having a mower deck and a mower blade is used to mow vegetation proximate to the fence, a distal end of the inclined side surface of each guard section extends under the mower blade as the mower deck abuts against and along the inclined side surfaces.

### CROSS-REFERENCE TO RELATED APPLICATIONS

This application is a non-provisional of, and claims the benefit of the filing date of, U.S. Provisional Application 63/275,751, filed Nov. 4, 2021, entitled, “DEVICE AND METHODS FOR PREVENTING WEED GROWTH AND/OR GRASS GROWTH,” the contents of which are incorporated herein by reference in its entirety.

### TECHNICAL FIELD

. The present disclosure relates to a device and methods for preventing growth of weeds and/or grass as well as a device and methods for protecting an area enclosure apparatus from damage.

### BACKGROUND

Unwanted weeds and grass frequently grow under and around fences. This results in the inconvenience and nuisance of removing such unwanted weeds and grass, as well as difficulty in removing the unwanted weeds and grass.

In order to mitigate the invasion of weeds, methods such as chemical treatments, sheets, weed barrier systems, weed tilling, weed trimming with a weed trimmer and manual weed pulling, which is tedious and physically demanding, are generally used. Chemical treatments have disadvantages due to the chemicals utilized, which may kill some weed varieties, but can likewise be hazardous to garden plants as well as people and animals. Weed sheets generally involve a long black plastic sheet where holes are required for plant insertion. However, weed sheets are cumbersome and require creation of a hole for each plant. Tilling of weeds through use of a rototiller or the like is useful in large non-crop areas, such as between plant rows. However, tilling is not feasible in areas where garden plants are in close proximity to one another or where a fence is proximally located. Manual weed pulling is tedious, time consuming and physically demanding on the individual who weeds. If a gardener goes away for an extended time and does not tend regularly to the weed pulling, then weeds can quickly grow out of control.

Current weed removal devices for use around a fence or other area enclosure apparatus include, for example, weed trimming tools or other weed removal devices. Use of currently available weed removal devices often damage the lower portion of a fence and are time and labor intensive.

Accordingly, there is a need for improved devices and methods that prevent unwanted weed growth and unwanted grass growth in close proximity to a fence or other area enclosure apparatus.

The present disclosure is directed to overcoming these and other deficiencies in the art.

### BRIEF DESCRIPTION

The present disclosure offers advantages and alternatives over the prior art by providing a fence guard device. The fence guard device includes a plurality of guard sections that are is configured to be positioned under a fence and abutted together longitudinally along the fence. Once positioned under the fence, the fence guard sections each have an inclined side surface extending laterally from the fence. When a lawn mower having a mower deck and a mower blade is used to mow vegetation proximate to the fence, a distal end of the inclined side surface of each guard section extends under the mower blade as the mower deck abuts against and along the inclined side surfaces. Accordingly, the inclined side surfaces of the fence guard device provide a positive guide for the mower deck of the lawn mover to follow and, when the distal ends of the inclined side surfaces of each guard section extends under the mower blade, the vegetation gets cut by the mower blade up to the distal ends of the inclined side surfaces of each guard section.

A fence guide device in accordance with one or more aspects of the present disclosure includes a first guard section and a second guard section. Each guard section includes a top and a bottom surface substantially parallel to each other. An inclined side surface extends laterally between the top and bottom surfaces. The first and second guard sections are configured to be positioned under a fence and abutted together at respective longitudinal ends of each guard section. When a lawn mower having a mower deck and a mower blade is used to mow vegetation proximate to the fence, a distal end of the inclined side surface of each guard section extends under the mower blade as the mower deck abuts against and along the inclined side surfaces.

In some examples of the present disclosure, when the distal ends of the inclined side surfaces of each guard section extends under the mower blade, the vegetation gets cut by the mower blade up to the distal ends of the inclined side surfaces of each guard section.

In some examples of the present disclosure, a longitudinally extending groove is disposed in the top surface or the inclined surface of each guard section. When the first and second guard sections are abutted together and positioned under the fence, the fence fits within each groove of the first and second guard sections.

In some examples of the present disclosure, the top surface and the bottom surface of each guard section is spaced apart by a section depth. The groove of each guard section has a groove depth that is less than the section depth of each guard section. Additionally, the groove of each guard section does not extend through to the bottom surface of each guard section.

In some examples of the present disclosure, the first and the second guard section each include a channel border portion disposed in the respective longitudinal end of each guard section. When the first and second guard sections are abutted together, the channel border portions of each guard section abut together to form a channel therebetween. The channel is configured to receive a post of the fence therein.

In some examples of the present disclosure, the channel border portions of the first and second guard sections being operable to form an open channel that partially receives the post of the fence when the first and second guard sections are abutted together. Additionally, a third guard section is operable to abut against the channel border portions of the first and second guard sections to form a closed channel that surrounds the post of the fence.

In some examples of the present disclosure, the inclined side surface and the bottom surface of each section form an acute angle at the distal end of the inclined side surface.

In some examples of the present disclosure, the acute angle formed between the inclined side surface and the bottom surface is about between 70 degrees and 30 degrees.

In some examples of the present disclosure, the first and second guard sections are secured by fasteners when abutted together.

In some examples of the present disclosure, the first and second guard sections are secured together by tongue and groove fasteners disposed on the first and second guard sections.

Another fence guide device in accordance with one or more aspects of the present disclosure includes a first guard section and a second guard section configured to be positioned under a fence and abutted together at respective longitudinal ends of each guard section. The first and second guard sections each include a top surface and a bottom surface substantially parallel to each other and spaced apart by a section depth. An inclined side surface extends laterally between the top and bottom surfaces. The inclined side surface forms an acute angle with the bottom surface. A groove is disposed in the top surface or the inclined surface. The groove extends longitudinally along a length of the guard section. A channel border portion is disposed in the respective longitudinal end of each guard section. When the first and second guard sections are abutted together and positioned under the fence, the fence fits within the groove of the first and second sections and the channel border portions of the first and second guard sections abut to form a channel within which the post of the fence fits. When a lawn mower having a mower deck and a mower blade is used to mow vegetation proximate to the fence, a distal end of the inclined side surfaces of each guard section extends under the mower blade as the mower deck abuts against the inclined side surfaces.

A method for preventing weed growth and/or grass growth in accordance with one or more aspects of the present disclosure includes providing a fence guard device having a first and a second guard section. Each guard section includes a top and a bottom surface substantially parallel to each other, a channel border portion disposed on a longitudinal end, and an inclined side surface extending laterally between the top and bottom surfaces. The first and second guard sections are abutted together under a fence. The channel border portions of each guard section are abutted together to form a channel therebetween such that the channel receives at least a portion of a post of the fence therein. Vegetation proximate to the fence is mowed using a lawn mower having a mower deck and a mower blade. The mower deck is abutted against and along the inclined side surfaces of each guard section such that a distal end of the inclined side surface of each guard section extends under the mower blade. The vegetation is cut with the mower blade up to the distal ends of the inclined side surfaces of each guard section.

In some examples of the method of the present disclosure, a longitudinally extending groove is disposed in the top surface or the inclined surface of each guard section. Additionally, the fence is fit within each groove of the first and second guard sections when the first and second guard sections are abutted together and positioned under the fence.

In some examples of the method of the present disclosure, the first and second guard sections are fastened together with fasteners when the first and second guard sections are positioned under the fence.

It should be appreciated that all combinations of the foregoing concepts and additional concepts discussed in greater detail below (provided such concepts are not mutually inconsistent) are contemplated as being part of the inventive subject matter disclosed herein and may be used to achieve the benefits and advantages described herein.

### DRAWINGS

The disclosure will be more fully understood from the following detailed description taken in conjunction with the accompanying drawings, in which:

FIG. 1 depicted an example of a type of a fence that is protected by a fence guard system, in accordance with aspects described herein;

FIG. 2 depicted another example of a type of a fence that is protected by a fence guard system, in accordance with aspects described herein;

FIG. 3 depicts an example of a top perspective view of a fence guard device, in accordance with aspects described herein;

FIG. 4 depicts an example of a cross sectional view of the fence guard device of FIG. 3 taken along the line 4-4 of FIG. 3, in accordance with aspects described herein;

FIG. 5 depicts an example of a perspective view of a lawn mower being used to mow vegetation proximate to a fence that is protected by a fence guard device, in accordance with aspects described herein;

FIG. 6A depicts an example of a cross sectional view of the lawn mower of FIG. 5, in accordance with aspects described herein;

FIG. 6B depicts another example of a cross sectional view of the lawn mower of FIG. 5, in accordance with aspects described herein;

FIG. 7 depicts another example of a top perspective view of a fence guard device, in accordance with aspects described herein;

FIG. 8 depicts an example of a top view of the fence guard device, wherein the first and second guard sections are secured together with fasteners, in accordance with aspects described herein;

FIG. 9A depicts an example of a top view of a straight first guard section of the fence guard device, wherein the first guard section secures to a second guard section with tongue and groove fasteners, in accordance with aspects described herein;

FIG. 9B depicts an example of a top view of a right angle second guard section of the fence guard device, wherein the second guard section secures to a first guard section with tongue and groove fasteners, in accordance with aspects described herein;

FIG. 10A depicts an example of a side cross sectional views of the fence system, wherein the groove is disposed entirely in the top surface of the first guard section, in accordance with aspects described herein;

FIG. 10B depicts an example of a side cross sectional views of the fence system, wherein the groove is disposed partially in the top surface and partially in the inclined side surface of the first guard section, in accordance with aspects described herein;

FIG. 10C depicts an example of a side cross sectional views of the fence system, wherein the groove is disposed entirely in the inclined side surface of the first guard section, in accordance with aspects described herein;

FIG. 11A depicts an example of a top perspective view of the fence system, wherein the shape of the channel, the position of the groove and the way the first and second guard sections abut together are configured in a certain way, in accordance with aspects described herein;

FIG. 11B depicts another example of a top perspective view of the fence system, wherein the shape of the channel, the position of the groove and the way the first and second guard sections abut together are configured in a certain way, in accordance with aspects described herein;

FIG. 11C depicts another example of a top perspective view of the fence system, wherein the shape of the channel, the position of the groove and the way the first and second guard sections abut together are configured in a certain way, in accordance with aspects described herein;

FIG. 11D depicts another example of a top perspective view of the fence system, wherein the shape of the channel, the position of the groove and the way the first and second guard sections abut together are configured in a certain way, in accordance with aspects described herein;

FIG. 11E depicts another example of a top perspective view of the fence system, wherein the shape of the channel, the position of the groove and the way the first and second guard sections abut together are configured in a certain way, in accordance with aspects described herein;

FIG. 11F depicts another example of a top perspective view of the fence system, wherein the shape of the channel, the position of the groove and the way the first and second guard sections abut together are configured in a certain way, in accordance with aspects described herein; and

FIG. 12 depicts an example of a flow diagram of a method of preventing weed growth or grass growth, in accordance with aspects described herein.

### DETAILED DESCRIPTION

Certain examples will now be described to provide an overall understanding of the principles of the structure, function, manufacture, and use of the methods, systems, and devices disclosed herein. One or more examples are illustrated in the accompanying drawings. Those skilled in the art will understand that the methods, systems, and devices specifically described herein and illustrated in the accompanying drawings are non-limiting examples and that the scope of the present disclosure is defined solely by the claims. The features illustrated or described in connection with one example maybe combined with the features of other examples. Such modifications and variations are intended to be included within the scope of the present disclosure.

The terms “significantly”, “substantially”, “approximately”, “about”, “relatively,” or other such similar terms that may be used throughout this disclosure, including the claims, are used to describe and account for small fluctuations, such as due to variations in processing from a reference or parameter. Such small fluctuations include a zero fluctuation from the reference or parameter as well. For example, they can refer to less than or equal to ± 10%, such as less than or equal to ± 5%, such as less than or equal to ± 2%, such as less than or equal to ± 1%, such as less than or equal to ± 0.5%, such as less than or equal to ± 0.2%, such as less than or equal to ± 0. 1%, such as less than or equal to ± 0.05%.

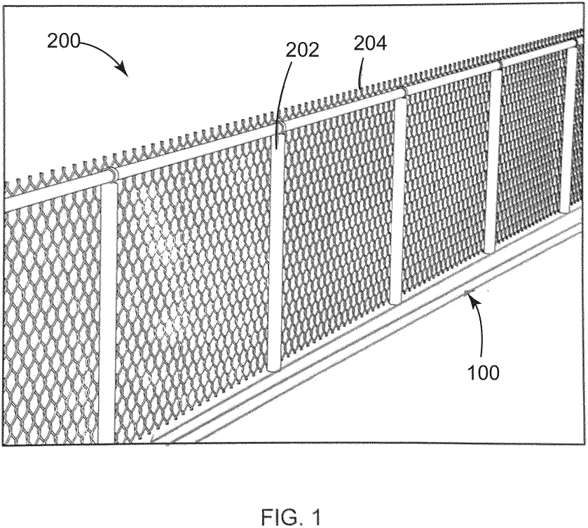

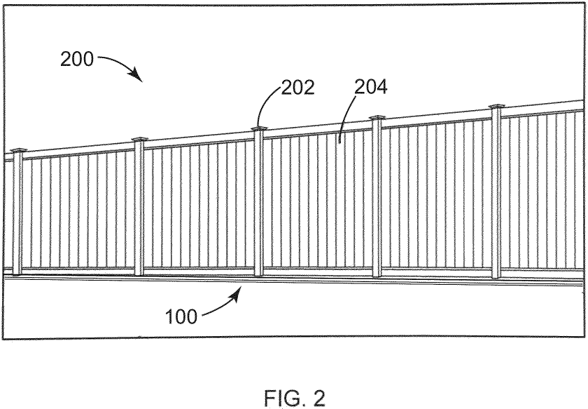

Referring to FIGS. 1 and 2, examples are depicted of at least two types of a fence 200 that is protected by a fence guard system 100, according to aspects described herein. The fence 200 may be any suitable type of fence system, such as chain link fences (FIG. 1), wood fences (FIG. 2), wrought iron fences (not shown) or the like. The fences 200 may include a longitudinally extending fence body 204 supported by fence posts 202.

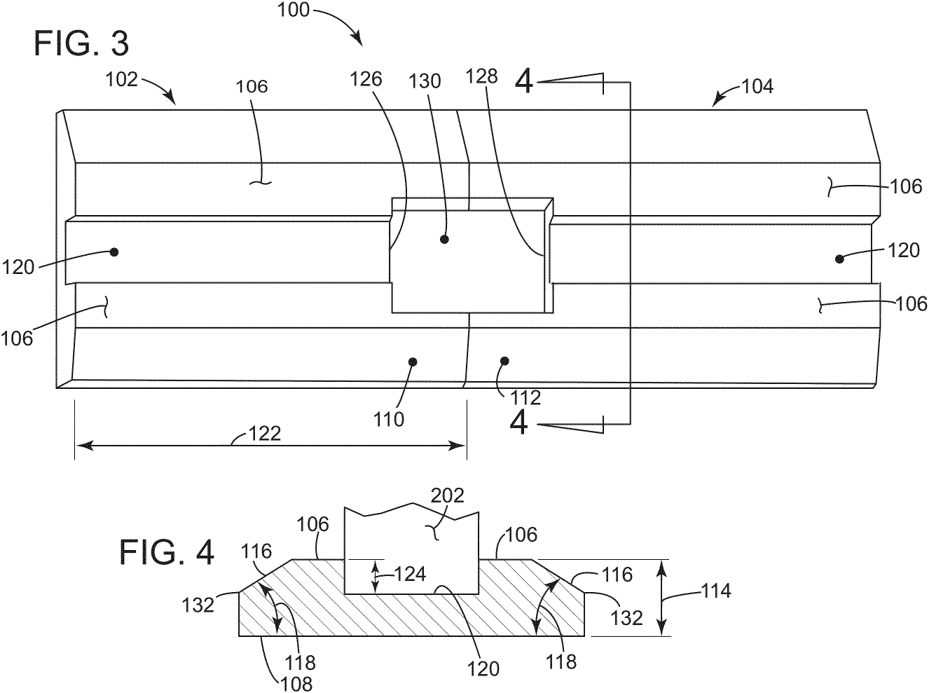

Referring to FIG. 3 an example is depicted of a top perspective view of a fence guard device 100 (such as illustrated in FIGS. 1 and 2), according to aspects described herein. Also, referring to FIG. 4, an example is depicted of a cross sectional view of the fence guard device 100 taken along the line 2-2 of FIG. 3, according to aspects described herein. The fence guard device 100 may be composed of any suitable material.

The fence guard device 100 may include a plurality of guard sections, such as first guard section 102 and second guard section 104. Each guard section 102, 104 is configured to be positioned under a fence 200 (see FIGS. 1 and 2) and abutted together at respective longitudinal ends 110, 112 of each guard section 102, 104. The first and second guard sections 102, 104 each include a top surface 106 and a bottom surface 108 substantially parallel to each other and spaced apart by a section depth 114.

An inclined side surface 116 extends laterally between the top 106 and bottom surfaces 108. The inclined side surface 116 forms an acute angle 118 with the bottom surface 108. The acute angle 118 may be, for example, between 30 degrees and 70 degrees.

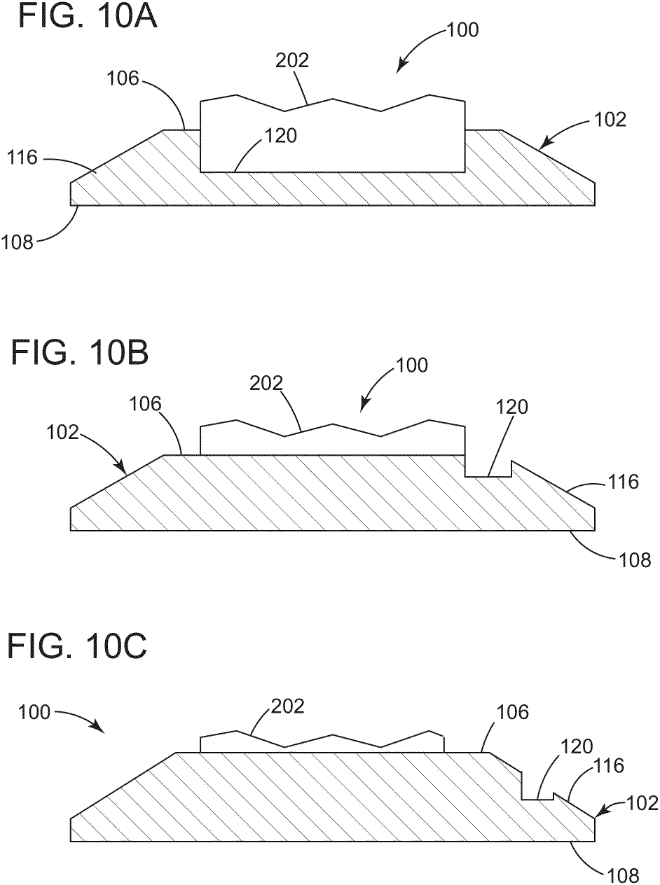

A longitudinally extending groove 120 may be disposed (or positioned) in either the top surface 106 or the inclined surface 116 of each guard section 102, 104. The groove 120 may extend longitudinally along a length 122 of each guard section 102, 104. In the example illustrated in FIGS. 3 and 4, the groove 120 is disposed in the top surface 106 of the guard sections 102, 104. However, as seen and discussed with reference to FIGS. 10A-10D, the groove 120 may also be disposed in the inclined side surface 116 of each guard section 102, 104.

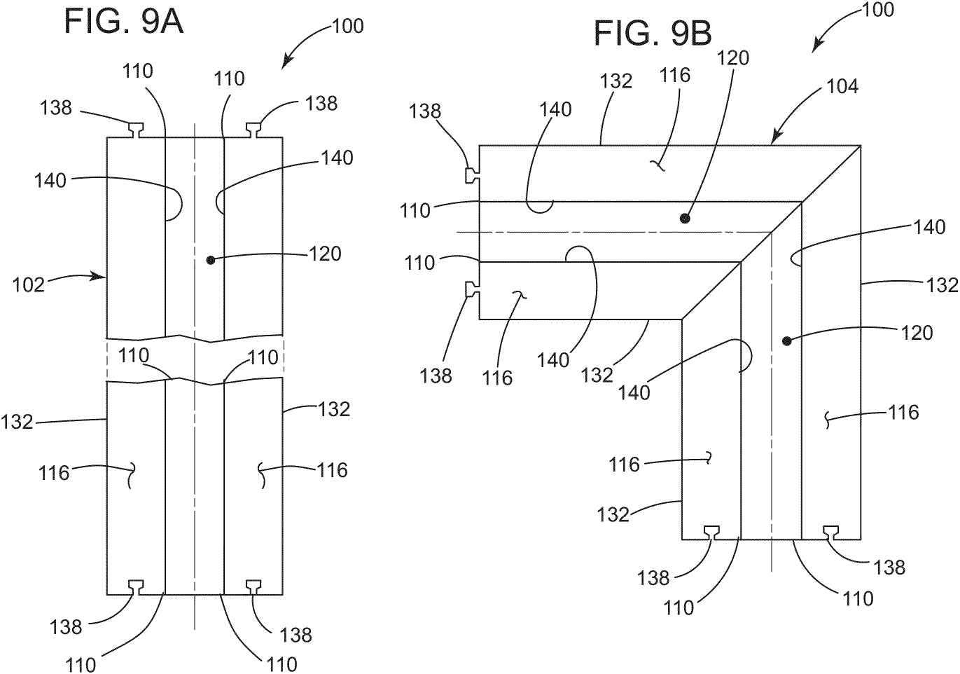

The top surface 106 may be small relative to the bottom surface 108. For example, as illustrated in FIG. 9, the top surface 106 may simply be a line shaped apex of the inclined side surface 116 intersecting a top edge of the groove 120.

When the first and second guard sections 102, 104 are abutted together and positioned under the fence 200, the body 204 of the fence 200 fits within each groove 120 of the first and second guard sections 102, 104. The groove 120 advantageously helps to maintain the guard sections 102, 104 in alignment under the fence 200, without having to modify the fence or without having to use attachment devices to secure the guard sections 102, 104 to the fence 200.

The groove 120 of each guard section 102, 104 has a groove depth 124 that is less than the section depth 114 of each guard section 102, 104. Additionally, the groove depth 124 does not extend through to the bottom surface 108 of each guard section 102, 104. As will be discussed in greater detail herein, the feature that the groove 120 does not penetrate through to the bottom surface 108 is true even if the groove 120 is disposed in the inclined side surface 116 rather than the top surface 106. Advantageously, by not extending the groove 120 through to the bottom surface 108, the entire area of the bottom surface 108 covers the vegetation under the guard sections 102, 104, including the area at the bottom of the groove 120. This helps to prevent any vegetation from growing under the fence 200 in locations that would be hard to reach and/or trim.

The first guard section 102 may include a channel border portion 124 and the second guard sections 104 may also include a channel border portion 126. The channel border portions 124, 126 may be disposed in the respective longitudinal end 110, 112 of each guard section 102, 104. When the first and second guard sections 102, 104 are abutted together, the channel border portions 126, 128 of each guard section 102, 104 abut together to form a channel 130 therebetween. The channel 130 is configured to receive a post 202 of the fence 200 therein. Advantageously, the feature of the channel border portions 124, 126 forming a channel 130 that is operable to receive a post 202 of the fence 200 therein, enables the guard sections 102, 104 to extend along the body 204

Advantageously, therefore, when the first and second guard sections 102, 104 are abutted together and positioned under the fence 200, the body 204 of the fence 200 fits within the groove 120 of the first and second sections 102, 104. Additionally, the channel border portions 126, 128 of the first and second guard sections 102, 104 abut to form the channel 130 within which the post 202 of the fence 200 fits

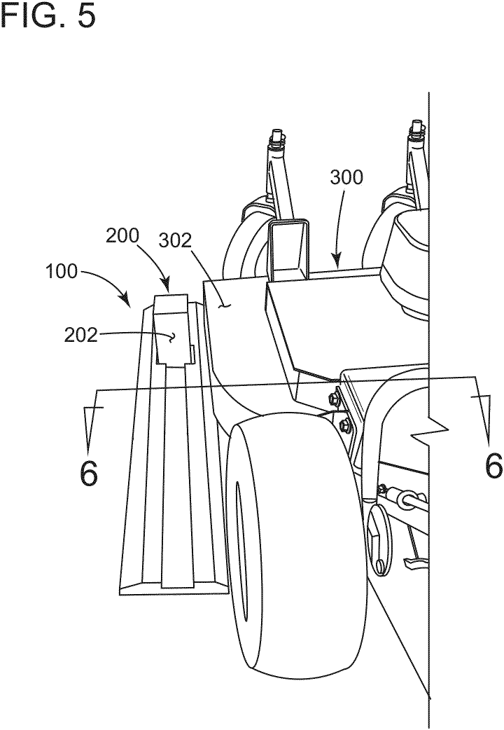

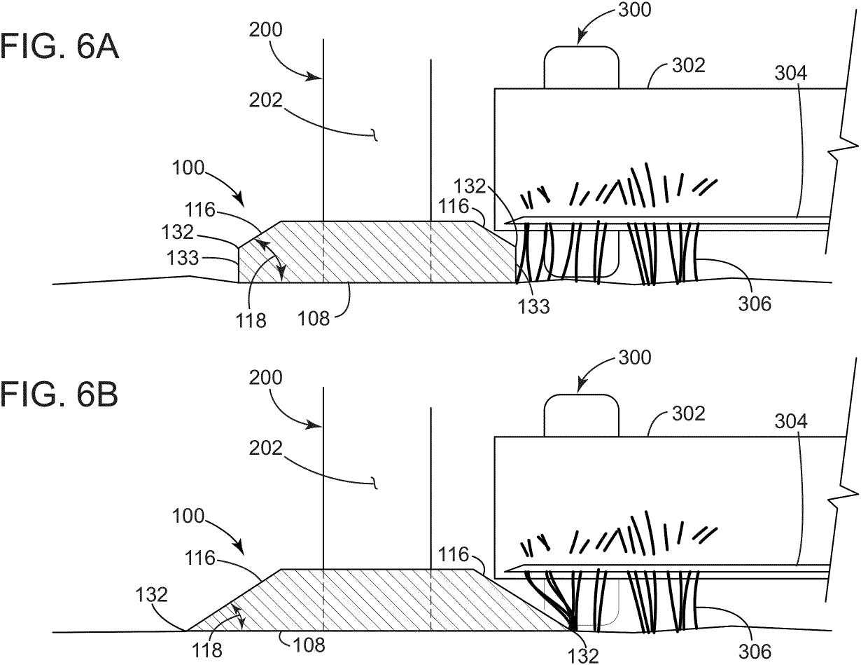

Also, advantageously (and as discussed in greater detail with reference to FIGS. 5 and 6 herein), when a lawn mower 300 having a mower deck 302 and a mower blade 304 is used to mow vegetation 306 proximate to the fence 200, a distal end 132 of the inclined side surfaces 116 of each guard section 102, 104 extends under the mower blade 304 as the mower deck 302 abuts against and along the inclined side surfaces 116. Accordingly, when the distal ends 132 of the inclined side surfaces 116 of each guard section 102, 104 extends under the mower blade 304, the vegetation 306 gets cut by the mower blade up 304 to the distal ends 132 of the inclined side surfaces 116 of each guard section 102, 104.

Referring to FIG. 5, an example is depicted of a perspective view of a lawn mower 300 being used to mow vegetation 306 proximate to the fence 200 that is protected by fence guard device 100, according to aspects described herein. Also, refereeing to FIG. 6A, an example is depicted of a cross sectional view of the lawn mower 300 of FIG. 5, taken along the line 6-6 of FIG. 5, according to aspects described herein.

The lawn mower 300 includes a mower deck 302 that houses a mower blade 304. The mower deck 302 is used to protect a user from the mower blade 304 during operation of the lawn mower 300. The mower deck 302 also provides a barrier to protect the blade 304 from being damaged by objects, such as the foundation of a building (now shown) or the body 204 and post 202 of the fence 200, that the mower is in proximity to.

When the fence guard device 100 is installed under the fence 200, and the mower is used to mow vegetation proximate to the fence 200, the distal end 132 of the inclined side surface 116 of each guard section 102, 104 is operable to extend under the mower blade 304 as the mower deck 302 abuts against and along the inclined side surfaces 116. In other words, the inclined side surfaces 116 of the fence guard device 100 provide a positive guide for the mower deck 302 of the lawn mower 300 to follow. When the distal ends 132 of the inclined side surfaces 116 of each guard section 102, 104 extend under the mower blade 304, the vegetation 306 gets cut by the mower blade 304 up to the distal ends 132 of the inclined side surfaces 116 of each guard section 102, 104. Advantageously, this leaves no additional unwanted vegetation 306 that needs to be cut or trimmed in the vicinity of the fence 200 by an additional operation (such as by trimming with a lawn trimmer).

It is important to note that in the example illustrated in FIG. 6A, the inclined surface 116 forms an acute angle 118 with the bottom surface 108, but does not extend all the way down to intersect with the bottom surface 108 of the fence guard sections 102, 104. Rather the distal end 132 of the inclined surface is positioned above the bottom surface. A vertical edge 133 connects the bottom surface 108 to the distal end 132 of the inclined surface 116. However, even though the distal end 132 of the inclined surface 116 does not intersect with the bottom surface 108, the distal end 132 still extends far enough to reach under the mower blade 304 as the mower deck 302 abuts against and along the inclined side surfaces. 116, so that the vegetation 306 gets cut by the mower blade 304 up to the distal ends 132 of the inclined side surfaces 116 of each guard section 102, 104.

Referring to FIG. 6B, another example is depicted of a cross sectional view of the lawn mower 300 of FIG. 5, taken along the line 6-6 of FIG. 5, according to aspects described herein. In this example, the inclined surfaces 116 extend all the way down to the bottom surface 108 to form the acute angle 118. Additionally, the distal ends 132 form the intersection between the inclined side surface 116 and the bottom surface 108 of the fence guard device 100. Again, the inclined surface 116 extends far enough to reach under the mower blade 304 as the mower deck 302 abuts against and along the inclined side surfaces 116, so that the vegetation 306 gets cut by the mower blade 304 up to the distal ends 132 of the inclined side surfaces 116 of each guard section 102, 104.

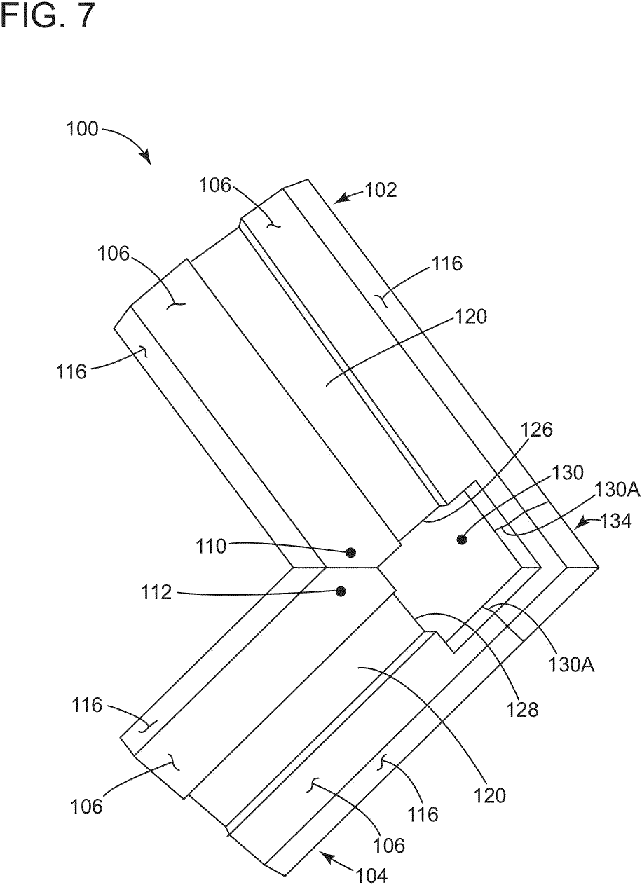

Referring to FIG. 7, another example is depicted of a top perspective view of a fence guard device 100, according to aspects described herein. In this example, the first and second guard sections 102, 104 are configured to abut together at substantially right angle to each other. This type of configuration may be used to deploy the fence guard device 100 around a corner of a fence 200.

In the example illustrated in FIG. 7, the channel border portions 126, 128 of the first and second guard sections 102, 104 are operable to form an open channel 130A that partially receives the post 202 of the fence 200 when the first and second guard sections 102, 104 are abutted together. In that case, a third guard section 134 may be operable and utilized to abut against the channel border portions 126, 128 of the first and second guard sections 102, 104 to form a closed channel 130 that surrounds the post 202 of the fence 200. The third guard section 134 may also help prevent vegetation growth around the rear of the fence 200.

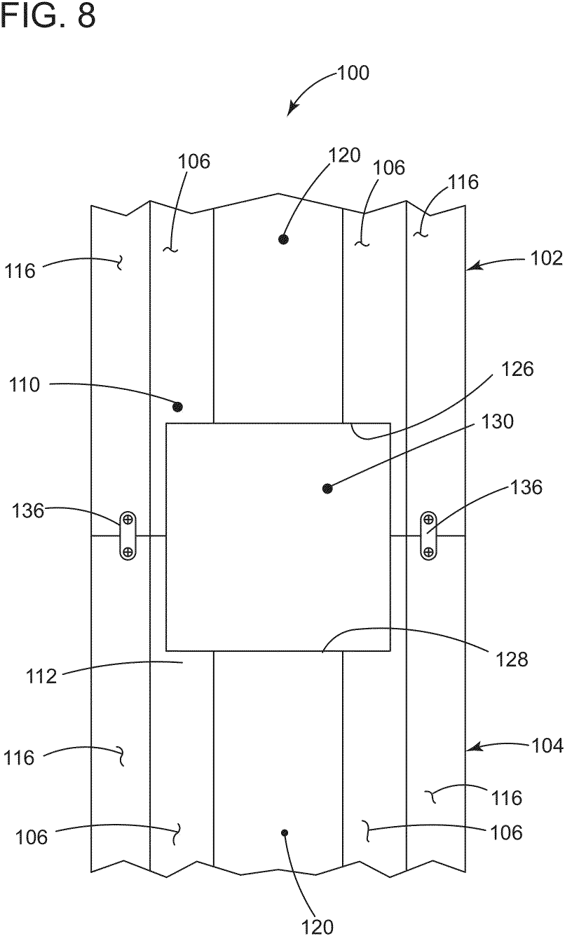

Referring to FIG. 8, an example is depicted of a top view of the fence guard device 100 wherein the first and second guard sections 102, 104 are secured together with fasteners 136 when the first and second guard sections 102, 104 are abutted together, in accordance with aspects described herein. In the example illustrated in FIG. 8, the fasteners 136 are bar fasteners that may be screwed into both longitudinal ends 110, 112 of their respective guard sections 102, 104. However, any appropriate fastener or fastener system may be used to secure the guard sections 102, 104 together.

Referring to FIGS. A. 9A and 9B, examples are depicted of top views of the first fence guard section 102 (FIG. 9A) and second guard section 104 (FIG. 9B) of the fence guard device 100, wherein the first and second guard sections 102, 104 are secured together with tongue and groove fasteners 138 when the first and second guard sections 102, 104 are abutted together, in accordance with aspects described herein. In the example illustrated in FIG. 9A, the first guard section 102 is a straight section, while in FIG. 9B the second guard section 104 is a right angle section. Additionally, the inclined surfaces 116 extend from an upper distal edge 140 of the groove 120 all the way down to the distal end 132 of the inclined side surface 116 where the inclined side surface intersects with the bottom surface 108 to form the acute angle 118 (see FIG. 6B). As such, the top surface 110 is simply the line formed by the intersection of the upper distal edge 140 of the groove 120 and the upper end of the inclined side surface 116.

Referring to FIGS. 10A, 10B and 10C, various examples are depicted of side cross sectional views of the fence system 100, wherein the groove 120 is disposed in either the top surface 106 or the inclined side surface 116 of the first guard section 102, in accordance with aspects described herein. In FIG. 10A, the groove 120 is disposed entirely in the top surface 106. In FIG. 10B, the groove 120 is disposed partially in the inclined side surface 116 and partially in the top surface 106. In FIG. 10C, the groove 120 is disposed entirely in the inclined side surface 106.

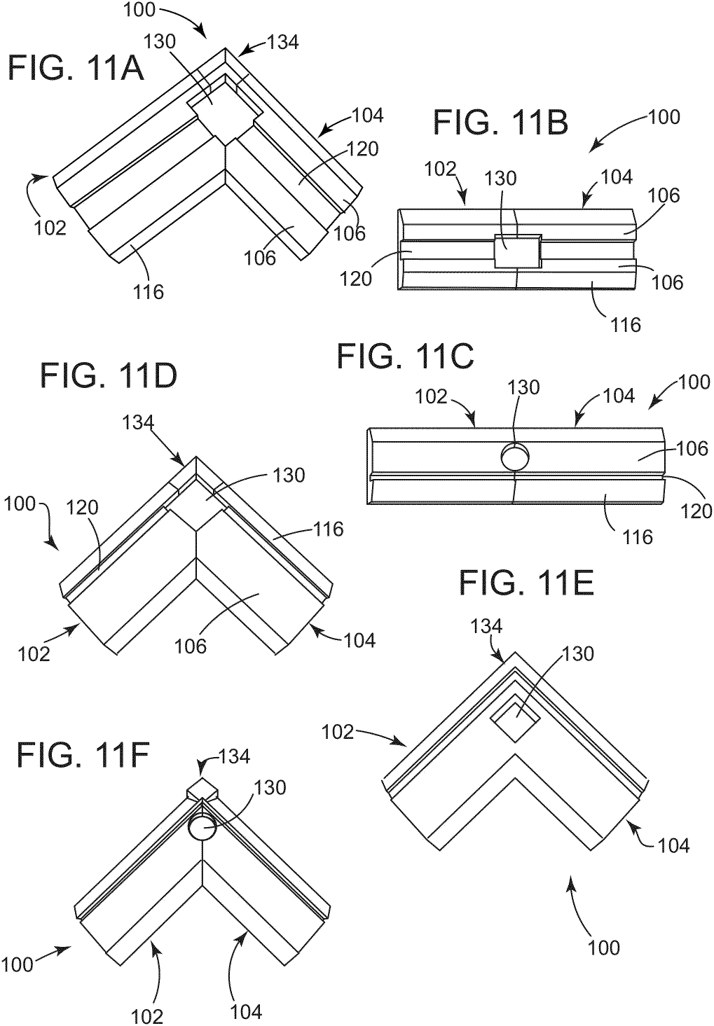

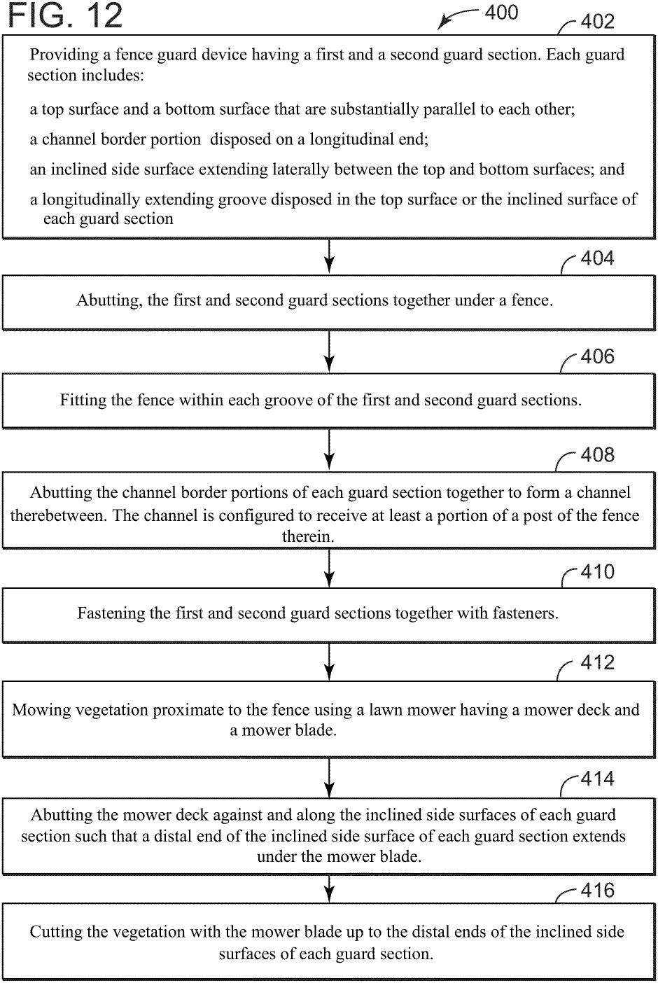

Referring to FIGS. 11A-11E, various examples are depicted of top perspective views of the fence system 100, wherein the shape of the channels 130, the position of the groove 120 and the way the first and second guard sections 102, 104 abut together changes, in accordance with aspects described herein.

In FIG. 11A, the first and second guard sections 102, 104 abut together at substantially right angles and further abut with a third guard section 134 to form a substantially square channel 130. The groove 120 is in the top surface 106.

In FIG. 11B, the first and second guard sections 102, 104 abut together in a substantially straight line to form a substantially rectangular channel 130. The groove 120 is in the top surface 106

In FIG. 11C, the first and second guard sections 102, 104 abut together in a substantially straight line to form a substantially round channel 130. The groove 120 is in the inclined side surface 116.

In FIG. 11D, the first and second guard sections 102, 104 abut together at substantially right angles and further abut with a third guard section 134 to form a substantially square channel 130. The groove 120 is in the inclined side surface 116.

In FIG. 11E, the first and second guard sections 102, 104 abut together at substantially right angles and further abut with a third guard section 134 to form a substantially square channel 130. The groove 120 is in the inclined side surface 116.

In FIG. 11F, the first and second guard sections 102, 104 abut together at substantially right angles and further abut with a third guard section 134 to form a substantially round channel 130. The groove 120 is in the inclined side surface 116.

Referring to FIG. 12, an example is depicted of a flow diagram of a method 400 of preventing weed growth or grass growth, in accordance with aspects described herein.

The method 400 begins at 402, wherein a fence guard device 100 is provided. The fence guard device includes a first and a second guard section 102, 104. Each guard section 102, 104 includes:
a top surface 106 and a bottom surface 108 that are substantially parallel to each other;
a channel border portion 126, 128 disposed on a longitudinal end 110, 112;
an inclined side surface 116 extending laterally between the top and bottom surfaces 106, 108; and
a longitudinally extending groove disposed in the top surface or the inclined surface of each guard section.

At 404 of method 400, the first and second guard sections 102, 104 are abutted together under a fence 200.

At 406, the fence 200 is fit within each groove 120 of the first and second guard sections 102, 104. More specifically, the longitudinal body 204 of the fence 200 is fit within the groove 120. The groove helps to secure the guard sections 102, 104 in place.

At 408 of method 400, the channel border portions 126, 128 of each guard section 102, 104 are abutted together to form a channel 130 therebetween. The channel is configured to receive at least a portion of a post 202 of the fence 200 therein. Advantageously, the channel 130 enables the first and second guard sections 102, 104 to be placed around the fence posts 202 of the fence 200 without modifying or damaging the fence posts 202.

At 410, the first and second guard sections 102, 104 are fastened together with fasteners 136 when the first and second guard sections 102, 104 are positioned under the fence 200. The fasteners may be tongue and groove fasteners 138.

At 412, vegetation 306 proximate to the fence 200 is mowed using a lawn mower 300 having a mower deck 302 and a mower blade 304.

At 414 of method 400, the mower deck 302 is made to abut against and along the inclined side surfaces 116 of each guard section 102, 104 such that a distal end 132 of the inclined side surface 116 of each guard section 102, 104 extends under the mower blade 304.

At 416 of the method, the vegetation 306 is with the mower blade 304 up to the distal ends 132 of the inclined side surfaces 116 of each guard section 102, 104.

Advantageously, the method 400 enables a user of the lawn mower 300 to use the inclined side surfaces 116 of the fence guard device 100 as a positive guide for the mower deck 302 of the lawn mower 300 to follow. Using the inclined side surfaces 116 as a positive guide enables the distal ends 132 of the inclined side surfaces 116 of each guard section 102, 104 to extend under the mower blade 304. Therefore, the vegetation 306 gets cut by the mower blade 304 up to the distal ends 132 of the inclined side surfaces 116 of each guard section 102, 104. This leaves no additional unwanted vegetation 306 that needs to be cut or trimmed in the vicinity of the fence 200 by an additional operation (such as by trimming with a lawn trimmer).

The disclosure has been described with reference to the preferred embodiments. It will be understood that the architectural and operational embodiments described herein are exemplary of a plurality of possible arrangements to provide the same general features, characteristics, and general system operation. Modifications and alterations will occur to others upon a reading and understanding of the preceding detailed description. It is intended that the disclosure be construed as including all such modifications and alterations.

It should be appreciated that all combinations of the foregoing concepts and additional concepts discussed in greater detail herein (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

Although the invention has been described by reference to specific examples, it should be understood that numerous changes may be made within the spirit and scope of the inventive concepts described. Accordingly, it is intended that the disclosure not be limited to the described examples, but that it have the full scope defined by the language of the following claims.

What is claimed is:

1. A fence guard device comprising:
a first guard section and a second guard section, each guard section comprising:
a top and a bottom surface substantially parallel to each other, and
an inclined side surface extending laterally between the top and bottom surfaces;
wherein, the first and second guard sections are configured to be positioned under a fence and abutted together at respective longitudinal ends of each guard section; and
wherein, when a lawn mower having a mower deck and a mower blade is used to mow vegetation proximate to the fence, a distal end of the inclined side surface of each guard section extends under the mower blade as the mower deck abuts against and along the inclined side surfaces.

2. The fence guard device of claim 1, wherein, when the distal ends of the inclined side surfaces of each guard section extends under the mower blade, the vegetation gets cut by the mower blade up to the distal ends of the inclined side surfaces of each guard section.

3. The fence guard device of claim 1, comprising:
a longitudinally extending groove disposed in the top surface or the inclined surface of each guard section;
wherein, when the first and second guard sections are abutted together and positioned under the fence, the fence fits within each groove of the first and second guard sections.

4. The fence guard device of claim 3, comprising:
the top surface and the bottom surface of each guard section being spaced apart by a section depth;
the groove of each guard section having a groove depth that is less than the section depth of each guard section; and
the groove of each guard section not extending through to the bottom surface of each guard section.

5. The fence guard device of claim 1, comprising:
the first and the second guard section each comprising a channel border portion disposed in the respective longitudinal end of each guard section, and
wherein, when the first and second guard sections are abutted together, the channel border portions of each guard section abut together to form a channel therebetween, the channel being configured to receive a post of the fence therein.

6. The fence guard device of claim 5, comprising:
the channel border portions of the first and second guard sections being operable to form an open channel that partially receives the post of the fence when the first and second guard sections are abutted together; and
a third guard section operable to abut against the channel border portions of the first and second guard sections to form a closed channel that surrounds the post of the fence.

7. The fence guard device of claim 1, wherein the inclined side surface and the bottom surface of each section form an acute angle at the distal end of the inclined side surface.

8. The fence guard device of claim 7, wherein the acute angle formed between the inclined side surface and the bottom surface is about between 70 degrees and 30 degrees.

9. The fence guard device of claim 1, wherein the first and second guard sections are secured by fasteners when abutted together.

10. The fence guard device of claim 9, wherein the first and second guard sections are secured together by tongue and groove fasteners disposed on the first and second guard sections.

11. A fence guard device comprising:
a first guard section and a second guard section configured to be positioned under a fence and abutted together at respective longitudinal ends of each guard section, the first and second guard sections each comprising:
a top surface and a bottom surface substantially parallel to each other and spaced apart by a section depth,
an inclined side surface extending laterally between the top and bottom surfaces, the inclined side surface forming an acute angle with the bottom surface,
a groove disposed in the top surface or the inclined surface, the groove extending longitudinally along a length of the guard section, and
a channel border portion disposed in the respective longitudinal end of each guard section, and
wherein, when the first and second guard sections are abutted together and positioned under the fence, the fence fits within the groove of the first and second sections and the channel border portions of the first and second guard sections abut to form a channel within which the post of the fence fits; and
wherein, when a lawn mower having a mower deck and a mower blade is used to mow vegetation proximate to the fence, a distal end of the inclined side surfaces of each guard section extends under the mower blade as the mower deck abuts against the inclined side surfaces.

12. The fence guard device of claim 11, comprising:
the groove of each guard section having a groove depth that is less than the section depth of each guard section.

13. The fence guard device of claim 11, comprising:
the groove of each guard section having a groove depth that does not extend through to the bottom surface of each guard section.

14. The fence guard device of claim 11, wherein the acute angle formed between the inclined side surface and the bottom surface of each guard section is about between 70 degrees and 30 degrees.

15. The fence guard device of claim 11, comprising:
the channel border portions of the first and second guard sections being operable to form an open channel that partially receives the post of the fence when the first and second guard sections are abutted together; and
a third guard section operable to abut against the channel border portions of the first and second guard sections to form a closed channel that surrounds the post of the fence.

16. The fence guard device of claim 11, wherein the first and second guard sections are secured by fasteners when abutted together.

17. The fence guard device of claim 16, wherein the fasteners are tongue and groove fasteners disposed on the first and second guard sections.

18. A method for preventing weed growth and/or grass growth, the method comprising:
providing a fence guard device having a first and a second guard section, each section comprising:
a top and a bottom surface substantially parallel to each other,
a channel border portion disposed on a longitudinal end, and
an inclined side surface extending laterally between the top and bottom surfaces;
abutting, the first and second guard sections together under a fence;
abutting the channel border portions of each guard section together to form a channel therebetween such that the channel receives at least a portion of a post of the fence therein;
mowing vegetation proximate to the fence using a lawn mower having a mower deck and a mower blade;
abutting the mower deck against and along the inclined side surfaces of each guard section such that a distal end of the inclined side surface of each guard section extends under the mower blade; and
cutting the vegetation with the mower blade up to the distal ends of the inclined side surfaces of each guard section.

19. The method of claim 18, comprising:
disposing a longitudinally extending groove in the top surface or the inclined surface of each guard section; and
fitting the fence within each groove of the first and second guard sections when the first and second guard sections are abutted together and positioned under the fence.

20. The method of claim 20, comprising:
fastening the first and second guard sections together with fasteners when the first and second guard sections are positioned under the fence.
